(19) United States
(12) Patent Application Publication
(10) Pub. No.: US 2011/0114093 A1
(43) Pub. Date: May 19, 2011

(54) AUTOMATIC FITMENT DETECTION AND FLOW CALIBRATION USING NON-CONTACT SENSING IN POWERED AIR PURIFYING RESPIRATORS

(75) Inventors: Swapnil Gopal Patil, Thane (IN); Nurul Hasan Ibrahim, Theni District (IN); Praveen Kumar Palacharla, Madinaguda (IN)

(73) Assignee: Honeywell International Inc., Morristown, NJ (US)

(21) Appl. No.: 12/618,940

(22) Filed: Nov. 16, 2009

(51) Int. Cl. A62B 7/00

(52) U.S. Cl. 128/204.19

(57) ABSTRACT

A method and apparatus for operating an powered, air-purifying respirator. The apparatus includes an air mask, an air pump, a hose connecting the mask to the air pump, a magnetic actuator disposed on a portion of the hose that engages a housing of the air pump and a controller that provides a predetermined air flow from the pump to the mask based upon a magnetic flux from the actuator.

### BACKGROUND OF THE INVENTION

The invention relates to air purifiers and more particularly to methods of controlling airflow in a powered air purifying respirators.

### BACKGROUND OF THE INVENTION

Powered air-purifying respirators (PAPRs) are generally known. Powered air-purifying respirators utilize a powered mechanism (e.g., a battery powered blower) to draw ambient air through an air-purifying element(s) where the air-purifying element(s) remove contaminants from the ambient air.

PAPRs are designed to provide respiratory protection against atmospheres with solid or liquid contaminants (e.g., dusts, mists, etc.), gases and/or vapors (e.g., fumes) where the concentrations also meet certain safety criteria. In this case, the criteria requires that the concentrations are not immediately dangerous to life or health and the atmosphere contains adequate oxygen to support life.

Powered air-purifying respirators are available in a number of different formats. For example, powered air-purifying respirators may be provided with either tight-fitting or loose-fitting headgear. In this regard, tight-fitting respirators may be provided with a half mask that covers the nose and mouth of a user or with a full mask that covers the face of a user from the hairline to below the chin. In contrast, loose-fitting respirators include masks with hoods or helmets that completely cover the head of the user.

The different types of headgear require different amounts of airflow. For example, the construction of tight-fitting masks causes air to be directly pushed into the nasal passages (and lungs) of a user. As a result, tight-fitting masks require a lower air flow while still providing good protection for the user.

In contrast, loose-fitting masks provide purified air on the face of a user which also cools the head portion of the user. Accordingly, loose-fitting masks require a greater air flow. Because of the importance of PAPRs, a need exists for better methods of calibrating air flow to the type of mask used.

### BRIEF DESCRIPTION OF THE DRAWINGS

FIGS. 1A-B depict an automatic air flow control system for PAPRs in accordance with an illustrated embodiment of the invention;

FIG. 2 depicts a hose coupling system that may be used with the system of FIG. 1;

FIG. 3 depicts a control schematic of the system of FIG. 1;

FIG. 4 is a flow chart of the system of FIG. 3;

FIG. 5 depicts additional details of the hose coupling system of FIG. 2;

FIG. 6 depicts voltage readings of the sensor of FIGS. 2 and 5; and

FIG. 7 depicts gauss readings of the sensor of FIGS. 2 and 5.

### DETAILED DESCRIPTION OF AN ILLUSTRATED EMBODIMENT

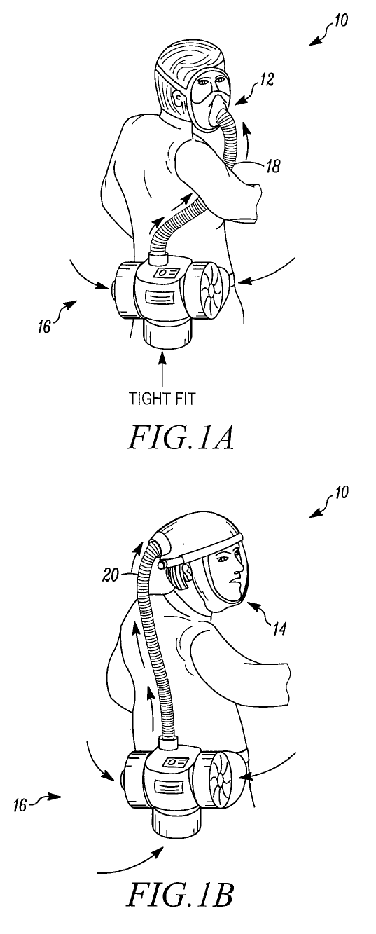

FIGS. 1A-B depict powered air-purifying respirators (PAPRs) 10 generally in accordance with an illustrated embodiment of the invention. FIG. 1A shows the PAPR 10 with a tight-fitting mask 12 and FIG. 1B shows the PAPR 10 with a loose-fitting mask 14.

Also shown in FIGS. 1A-B is an air pump 16. The air pump 16 is generally constructed of a direct current (dc) motor coupled to a turbo (centrifical) air blower. An air-purifying element or filter is coupled to an inlet of the air pump 16.

As shown in FIG. 1A a first hose 18 connects the tight-fitting mask 12 to the air pump 16 and a second hose 20 couples the loose-fitting mask 14 to the air pump 16. Generally, each of the hoses 18, 20 is either permanently attached to the respective mask 12, 14 or made specially for these masks (different color or construction).

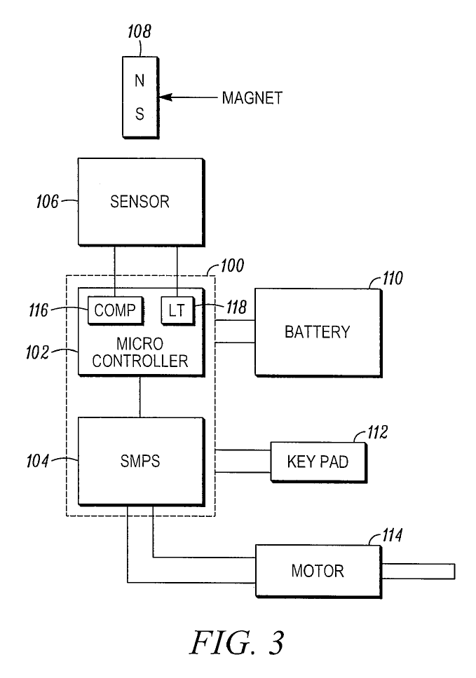

FIG. 3 is an electrical schematic of the PAPR 10. Under one illustrated embodiment of the invention, a processor 102 selectively connects the motor 114 to the battery 110 through a switched mode power supply (SMPS) 104. The speed of the motor 114 (and volume of air delivered to the mask 12, 14) is automatically determined by the processor 102 from the magnetic flux provided by a magnet 108 and sensed through a magnetic sensor 106.

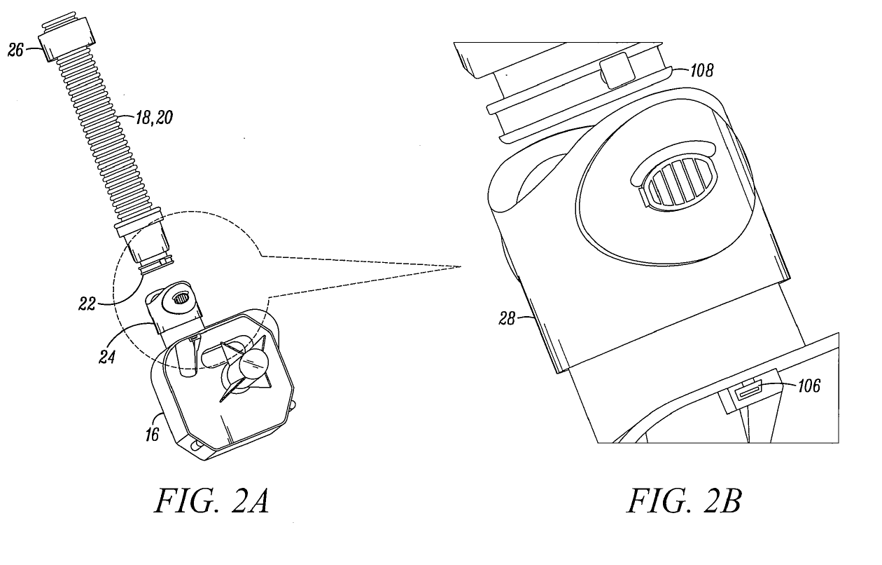

FIGS. 2A and 2B show details of the hose 18, 20, the magnet 108 and sensor 106. A first end 26 of the hose 18, 20 is permanently connected to the mask 12, 14. A second, distal end of the hose 18, 20 is detachably connected to the air pump 16.

The magnet 108 is attached by an appropriate technology (e.g., glue, screws, etc.) to an outer surface of a distal end 22 of the hose 18, 20. An outer diameter of the end 22 is of a lesser size than an inner diameter of a coupler 28 attached to the housing of the air pump 16.

As the distal end 22 of the hose 18, 20 is inserted into the coupling 28, the magnet 108 is brought into range of the sensor 106. In this regard, a rib on an outer surface of the distal end 22 may engage a groove on the inside of the coupler 28 so that the end 22 cannot be inserted into the coupler 28, unless the magnet 108 is aligned with the sensor 106.

The sensor 106 may operate under any of a number of different formats. For example, the sensor 106 may be a Hall effect sensor that provides a variable voltage output where the voltage depends upon the magnetic flux impinging on the sensor 106. Alternatively, the sensor 106 may be a magnetoresistive (MR) sensor, an anisotropic magnetoresistive (AMR) sensor or a giant magnetoresistive (GMR) sensor.

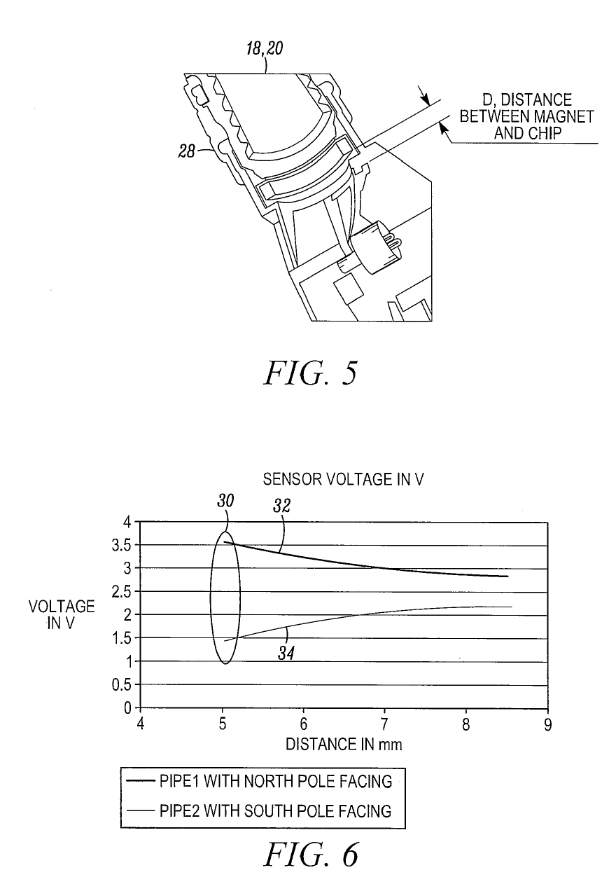

In general, the orientation and placement of the magnet 108 with regard to the sensor 106 is used to determine air flow from the air pump 16 to the mask 12, 14. For example, FIG. 5 shows the hose 18, 20 inserted into the coupling 28 where the magnet 108 is separated from the sensor 106 by a distance, D. In this case, the distance, D, may be used as a way of controlling the magnetic flux coupled to and detected by the sensor 106.

FIG. 6 shows a voltage output (e.g., an analog signal or digital signal) of the sensor 106 versus the distance, D, that separates the magnet 108 from the sensor 106. Under a first embodiment, the air flow (motor speed) is determined by an orientation of the magnet 108 with respect to the sensor 106. As shown in FIG. 6, if the hose 18, 20 has a north facing magnet (i.e., the north pole of the magnet 108 faces the sensor 106), then the voltage output of the sensor 106 varies from approximately 2.8 volts at 8.5 mm to a high of 3.5 volts at 5 mm while a south facing magnet would provide an output of approximately 2.2 volts at 8.5 mm and 1.4 volts at 5 mm. Under this embodiment, the tight-fitting mask 12 shown in FIG. 1A may be provided with the south pole of the magnet 108 that faces the sensor 106 and the loose-fitting mask 14 with a north pole of the magnet 108 facing the sensor 106.

Under this embodiment, the processor 102 reads the sensor output (analog or digital output) and determines the type of mask 12, 14 that is being used from the sensor voltage. In this case, voltage along curve 34 would indicate that a tight-fitting mask 12 is being used while a voltage along curve 32 would indicate that a loose-fitting mask 14 is being used.

If the processor 102 should automatically determine that a tight-fitting mask 12 is being used in the system 10, then the processor 102 may select a first air flow (e.g., 115 liters/minute for a moderate work rate or 170 liters/minute for a high work rate in accordance with NIOSH requirements). Similarly, if the processor 102 should determine that a loose-fitting mask 14 is being used, then the processor 102 may select a second air flow (e.g., 115 liters/minute for a low work rate, 170 liters/minute for a moderate work rate or 235 liters/minute for a high work rate).

The system 10 may be provided with a first ON/OFF switch or may be activated by the insertion of a hose 18, 20 into the air pump 16. Similarly, the air pump 16 may be provided with a second switch used to selecting either a moderate work rate of a high work rate.

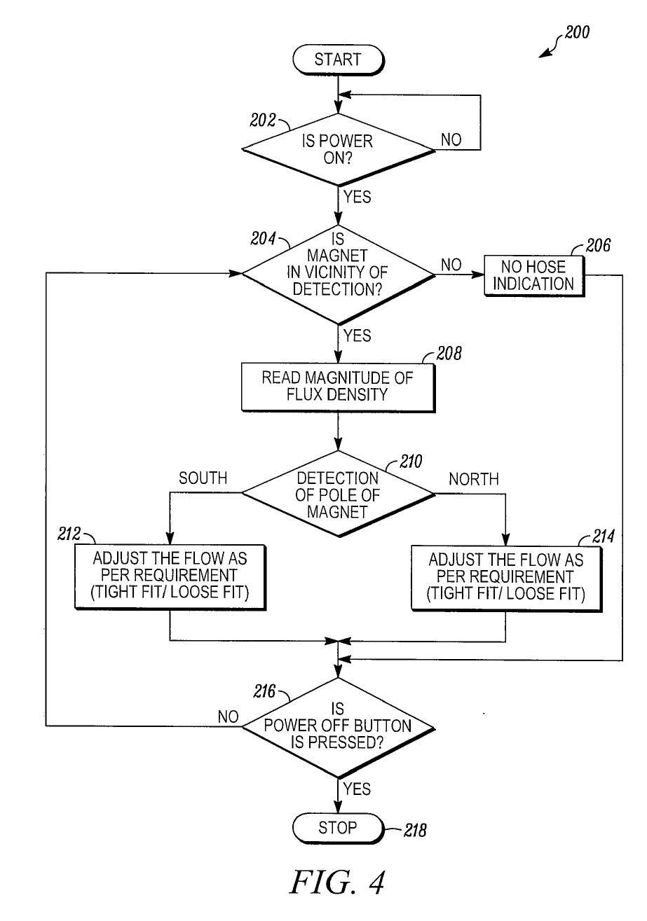

Once activated, the system 10 may operate as depicted in FIG. 4. In this regard, if power is on 202, then the processor 102 may collect readings from the sensor 106 to detect 204 if there is a magnet is in the vicinity of the sensor 106. If the sensor output is near to a neutral value (i.e., the sensor output corresponds to zero flux density), indicating that no hose is present 206, then the processor 102 may read 216 a power off button and stop 218 is the button is activated. Otherwise, the processor 102 may cycle through the loop including steps 204, 206, 216.

Alternatively, the processor 102 may detect 204 a magnet 108 in the vicinity of the sensor 106 via some minimum voltage reading. If so, then the processor may read 208 the flux density from the sensor 106.

From the flux density, the processor 102 may proceed to detect 210 the pole of the magnet 108 facing the sensor 106. The processor 102 may perform this step with the aid of a look up table 118 that contains the readings of curves 32, 34. In this regard, the processor 102 may use a comparator to compare the flux reading with the values in curve 32 and curve 34. Alternatively, if the sensor 106 is a Hall sensor, then the polarity of the magnet 108 may be determined from a polarity of the output of the sensor 106. Upon matching the reading with either a south or north pole, the processor 102 may retrieve 212, 214 a motor speed (air flow rate) and send an instruction (including the determined motor speed) to the SMPS 104. The SMPS 104 will receive the instruction and cause the motor 114 to operate at the desired speed.

It should be noted in this regard that the motor speed within the look up table 118 is matched to the magnet 108 that is detected. For example, if a south pole identifies a tight-fitting mask 12, then the motor speed value in the look up table 118 may have been determined experimentally for the specific type of tight-fitting mask 12 involved or for the specific mask 12 used. Similarly, if a north pole identifies a loose-fitting mask 14, then the motor speed value in the look up table 118 would be determined for the loose-fitting mask 14 in a similar manner.

In another embodiment, the distance, D, and orientation of the magnet 108 may be used to define a locus of possible locations along the ellipse 30 of FIG. 6. In this case, each location along the ellipse 30 may be matched to a corresponding air flow within the look up table 118.

In this embodiment, the processor 102 would first determine if a magnet 108 is in the vicinity 204 of the sensor 106. If so, then the processor would first read 208 a magnitude of the flux density. From the flux density, the processor 102 would determine or detect 210 the pole of the magnet 108 facing the sensor 106.

Once the pole has been determined, the processor 102 may use the comparator 116 and look up table 118 to determine the proper air flow 212, 214. In this case, the look up table 118 may contain two tables including one for a south facing pole and one for a north facing pole in which each read flux value corresponds to a specific predetermined air flow rate.

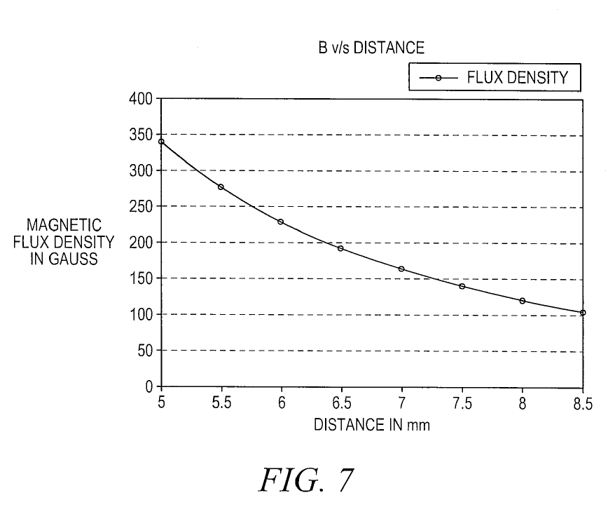

In still another embodiment, the distance, D, between the magnet 108 and sensor 106 may be used by itself to determine an air flow. In this case, the distance, D, is varied to define any number of air flow rates. For example, FIG. 7 shows sensor readings in terms of gauss versus distance. Alternatively, the strength of the magnetic field (in gauss) may be varied by varying the type and strength of the magnet 108.

As above, the processor 102 may first determine a pole 210 of the magnet 108 facing the sensor 106 based upon the output (analog/digital) of the sensor. Alternatively, the air flow for tight-fitting and loose-fitting masks 12, 14 may be determined directly from a gauss reading as shown in FIG. 4. In this case, the air flow may be chosen by the appropriate selection of the spacing, D, as shown in FIG. 4 or from the strength of the magnet 108. As above, the gauss reading may be retrieved by the processor 102 and the retrieved gauss reading may be used within the comparator 116 and look up table 118 to determine the proper air flow from the look up table 118 using the gauss reading to retrieve the air flow corresponding to that gauss reading.

The system 10 provides a number of advantages over conventional PAPRs. For example, there is no need to purchase different air pumps 16 for use with different masks 12, 14. This saves cost over conventional technologies because the automatic detection of required air flow allows for the standardization of PAPRs and for the use of interchangeable masks 12, 14.

Moreover, the unit 10 is safer. Generally, manual/human intervention in the calibration or tuning of air flow requirements of PAPRs 10 is considered dangerous. Under the claimed invention, unskilled users may simply retrieve the mask 12, 14 that is most comfortable for the user without concern for the mask 12, 14 or the particular air pump 16 that is to be used with the mask 12, 14.

A specific embodiment of an automatic air flow control system has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A powered, air-purifying respirator comprising:
an air mask;
an air pump;
a hose connecting the mask to the air pump;
a magnetic actuator disposed on a portion of the hose that engages a housing of the air pump; and
a controller that provides a predetermined air flow from the pump to the mask based upon a magnetic flux from the actuator.

2. The respirator as in claim 1 further comprising a magnetic flux detector coupled to the controller.

3. The respirator as in claim 2 further comprising the controller selecting a first predetermined airflow when the flux detector detects a south pole of the magnetic actuator and a second predetermined airflow upon detecting a north pole of the magnetic actuator.

4. The respirator as in claim 3 further comprising a flux measurement processor within the controller that measures a magnetic flux of the magnetic actuator.

5. The respirator as in claim 4 further comprising a look up table that correlates measured magnetic flux with predetermined air flow rates.

6. The respirator as in claim 5 further comprising a comparator that compares the measured magnetic flux with a set of flux values within the look up table and selects an air flow that substantially matches the measured flux value.

7. A powered, air-purifying respirator comprising:
an air pump;
a hose connecting an air mask to the air pump;
a magnet disposed on a portion of the hose that engages a housing of the air pump;
a sensor within the housing that detects the magnetic flux; and
a controller coupled to the sensor that provides a predetermined air flow from the pump to the mask based upon the detected magnetic flux.

8. The respirator as in claim 7 wherein the sensor further comprises a Hall effect sensor.

9. The respirator as in claim 7 wherein the sensor further comprises a magnetoresistive sensor.

10. The respirator as in claim 7 wherein the sensor further comprises an anisotropic magnetoresistive sensor.

11. The respirator as in claim 7 wherein the sensor further comprises a giant magnetoresistive sensor.

12. The respirator as in claim 7 further comprising a look up table to determine the air flow from the measured flux.

13. The respirator as in claim 12 wherein the look up table further comprising a first set of readings for a north pole and a second set of readings for a south pole of the magnet.

14. The respirator as in claim 12 further comprising a comparator that compares the flux reading to the entries within the look up table.

15. The respirator as in claim 7 further comprising a switched mode power supply that controls a speed of the air pump.

16. The respirator as in claim 7 further comprising a battery.

17. A method comprising:
coupling a hose of a powered air-purifying respirator to an air pump;
reading a magnetic flux coupled from a magnet on the hose to a sensor on the air pump;
determining an air flow from the flux.

18. The method as in claim 17 further comprising identifying a pole of the magnet facing the sensor.

19. The method as in claim 17 further comprising matching the flux reading to an air flow within a look up table.

20. The method as in claim 19 further comprising setting a speed of a motor of the air pump based upon the matched reading.
